(19) United States
(12) Patent Application Publication
(10) Pub. No.: US 2010/0319385 A1
(43) Pub. Date: Dec. 23, 2010

(54) CAM MECHANISM AND ICE MAKING DEVICE

(75) Inventor: Masako HASHIMOTO, Nagano (JP)

Correspondence Address: CANTOR COLBURN LLP, 20 Church Street, 22nd Floor, Hartford, CT, 06103, US

(73) Assignee: NIDEC SANKYO CORPORATION, Nagano (JP)

(21) Appl. No.: 12/817,927

(22) Filed: Jun. 17, 2010

(30) Foreign Application Priority Data
Jun. 17, 2009 (JP) 2009-144594

(51) Int. Cl. F25C 5/18; F16H 53/00; F16H 53/06

(52) U.S. Cl. 62/344; 74/567; 74/569

(57) ABSTRACT

A cam mechanism may include a rotation cam body, a first moved member which is urged so as to move along an inner side cam face formed on the rotation cam body, and a second moved member which is urged so as to move along an outer side cam face formed on the rotation cam body. An end face of the rotation cam body is formed with a surrounding wall part, a protruding part protruded from the end face on an inner peripheral side so as to face the surrounding wall part and, a part of which is formed as a discontinuity portion, and a recessed part formed so as to recess from the end face in an area sandwiched between the surrounding wall part and the discontinuity portion. The inner side cam face is structured of an inner wall face of the protruding part and an inner wall portion directing to an inner side in a radial direction of the recessed part. The cam mechanism may be effectively utilized in an ice making device.

### CROSS REFERENCE TO RELATED APPLICATION

The present invention claims priority under 35 U.S.C. §119 to Japanese Application No. 2009-144594 filed Jun. 17, 2009, the entire content of which is incorporated herein by reference.

### FIELD OF THE INVENTION

At least an embodiment may relate to a cam mechanism comprising two moved members and a rotation cam body provided with two cam faces along which two moved members are moved. Further, an embodiment may relate to an ice making device in which a scraping-out member for scraping out ice pieces from an ice tray, an ice detecting lever for detecting an ice quantity in an ice storage part, and a switch for detecting a position of the ice detecting lever are driven by the cam mechanism.

### BACKGROUND

An ice making device has been known which includes an ice detecting mechanism for driving an ice detecting lever toward an ice storage part to detect an ice quantity in an ice storage part, and an ice discharging mechanism for moving ice pieces manufactured in an ice tray to the ice storage part. In the ice making device, a cam mechanism is used for driving and controlling the ice detecting mechanism and the ice discharging mechanism in a cooperated manner. Further, an operation of the ice detecting lever which is driven by the ice detecting mechanism is transmitted to a switch through the cam mechanism to detect a position of the ice detecting lever on the basis of a signal outputted from the switch.

In the ice making device described in Japanese Patent Laid-Open No. 2001-165539, the ice discharging mechanism is structured so that an ice tray is turned in a predetermined angular range to drop manufactured ice pieces. A rotation shaft of the ice tray is connected with a rotation cam body to which a rotational drive force is transmitted from a drive source, and the rotation cam body is formed with an ice detecting lever driving cam face by which a first moved member for driving the ice detecting lever is moved and a lever position detecting cam face by which a second moved member for detecting a position of the ice detecting lever is moved. The ice detecting lever driving cam face is formed on an inner wall face of a first wall part which is protruded in a substantially parallel to a turning center axial line from an end face of the rotation cam body located on one side in the turning center axial line direction. The lever position detecting cam face is formed on an inner wall face of a second wall part which is protruded in a substantially parallel to the turning center axial line from the same end face of the rotation cam body. The ice detecting lever driving cam face and the lever position detecting cam face is separated from each other in a radial direction of the rotation cam body, and the lever position detecting cam face is located on an outer peripheral side of the ice detecting lever driving cam face.

In the ice making device described in Japanese Patent Laid-Open No. 2008-57894, the ice discharging mechanism is structured so that a scraping-out member is turned one rotation to scrape out ice pieces manufactured in an ice tray. A rotation shaft of the scraping-out member is connected with a rotation cam body to which a rotational drive force is transmitted from a drive source. The rotation cam body is formed with an ice detecting lever driving cam face by which a first moved member for driving an ice detecting lever is moved and a lever position detecting cam face by which a second moved member for detecting a position of the ice detecting lever is moved. The ice detecting lever driving cam face is formed on an outer wall face of a first protruded part which is protruded in a substantially parallel to a turning center axial line from an end face of the rotation cam body on one side in the turning center axial line direction. The lever position detecting cam face is formed on an outer wall face of a second protruded part which is protruded in a substantially parallel to the turning center axial line from the other end face of the rotation cam body in the rotation center axial line direction. The ice detecting lever driving cam face and the lever position detecting cam face are separated from each other in the turning axial line direction of the rotation cam body.

In the ice making device described in the above-mentioned former Patent Reference, as shown in FIG. 12, a lever driving cam face 101 which is structured on an inner peripheral side of a rotation cam body 100 is provided with a cam face portion 101a protruding toward an outer peripheral side. A protruding portion 102a of a first wall part 102 where the cam face portion 101a is formed is located at a near position to an outer circumferential edge of the rotation cam body 100.

In the ice making device described in the above-mentioned former Patent Reference, a turning range of the ice tray is less than one rotation and a turning angle of the rotation cam body 100 is set to be less than one rotation. Therefore, a moving trace 200A of the second moved member which is moved by the lever position detecting cam face 103 is moved within an area surrounded by the imaginary line in the drawing and the lever position detecting cam face 103. Accordingly, the second moved member is not interfered with the protruding portion 102a of the first wall part 102. However, in order to turn the rotation cam body 100 over one rotation so that a member driven by the ice discharging mechanism is capable of turning over one rotation, the second moved member and the cam face portion 101a are interfered with each other and the second moved member is abutted with the protruding portion 102a of the first wall part 102.

In this case, when a sufficient space is secured on an outer peripheral side of the protruding portion 102a of the first wall part 102 for allowing the second moved member to pass through and the lever position detecting cam face 103 is formed on an outer peripheral side of the space, the second moved member and the cam face portion 101a are not interfered with each other. Therefore, the rotation cam body 100 is capable of turning over one rotation without the second moved member and the protruding portion 102a of the first wall part 102 are not abutted with each other. However, according to this structure, a diameter of the rotation cam body 100 becomes larger and the first moved member and the second moved member which are moved by the respective cam faces 101 and 103 are required to arrange at remote positions in the radial direction of the rotation cam body 100 and thus the cam mechanism becomes larger and the size of the ice making device is not reduced.

Further, like the ice making device described in the above-mentioned latter Patent Reference, when the lever driving cam face 101 is structured on the end face on one side of the rotation cam body 100 and the lever position detecting cam face 103 is structured on the end face on its other side, the rotation cam body 100 is capable of turning over one rotation without the second moved member being abutted with the protruding portion 102a of the first wall part 102. However, according to this structure, a thickness of the rotation cam body 100 becomes larger in the rotation axial line direction. In addition, the first moved member and the second moved member which are moved by the respective cam faces 101 and 103 are required to arrange at remote positions in the turning axial line direction of the rotation cam body 100 and thus the cam mechanism becomes larger and the size of the ice making device is not reduced.

### SUMMARY

In view of the problems described above, at least an embodiment of the present invention may advantageously provide a cam mechanism which includes two moved members and a rotation cam body provided with two cam faces along which the two moved members are moved and whose size is smaller. Further, at least an embodiment of the present invention may advantageously provide an ice making device in which a scraping-out member which scrapes out ice pieces from an ice tray, an ice detecting lever which detects an ice quantity in an ice storage part, and a switch for detecting a position of the ice detecting lever are driven by the cam mechanism.

According to at least an embodiment of the present invention, there may be provided a cam mechanism including a rotation cam body, a first moved member which is urged toward an inner side cam face that is formed on the rotation cam body so as to move along the inner side cam face, and a second moved member which is urged toward an outer side cam face that is formed on the rotation cam body so as to move along the outer side cam face. An end face located on one side in a turning center axial line direction of the rotation cam body is formed with a surrounding wall part which is protruded from the end face, a protruding part which is protruded from the end face on an inner peripheral side with respect to the surrounding wall part so as to face the surrounding wall part and, a part of which is formed as a discontinuity portion, and a recessed part which is formed so as to recess from the end face in an area sandwiched between the surrounding wall part and the discontinuity portion. The outer side cam face is structured of an inner wall face of the surrounding wall part, and the inner side cam face is structured of an inner side cam face portion formed of an inner wall face of the protruding part and a second cam face portion formed of a wall portion directing to an inner side in a radial direction of the recessed part, and at least the outer side cam face is located on an outer side of the second cam face portion.

According to a cam mechanism in this embodiment of the present invention, the inner side cam face and the outer side cam face are structured on an inner peripheral side and an outer peripheral side of an end face located on one side in the turning center axial line direction of the rotation cam body. Therefore, in comparison with a case that the inner side cam face and the outer side cam face are separately structured on both end faces in the turning center axial line direction of the rotation cam body, the rotation cam body is prevented from becoming thicker in the turning center axial line direction. Further, a first moved member moving along the inner side cam face and a second moved member moving along the outer side cam face are not required to be disposed at remote positions from each other in the turning center axial line direction of the rotation cam body and thus the cam mechanism can be structured smaller in the turning center axial line direction. In addition, the inner side cam face is provided with a second cam face portion which is formed toward the outer side cam face from the protruding part but the second cam face portion is structured on an inner wall portion of the recessed part formed on the end face of the rotation cam body. As a result, the second moved member moving along the outer side cam face is capable of passing on an opening part of the recessed part. Therefore, even when a sufficient space for passing the second moved member is not provided between the second cam face portion of the inner side cam face and the outer side cam face, the second moved member is not interfered with a portion of the rotation cam body where the inner side cam face is formed. Accordingly, the outer side cam face can be structured at a nearer position to the turning center axial line of the rotation cam body. Further, the first moved member moving along the inner side cam face and the second moved member moving along the outer side cam face are capable of being disposed at nearer positions to the turning center axial line in the radial direction of the rotation cam body and thus the cam mechanism can be structured smaller in a direction perpendicular to the turning center axial line. Specifically, it is preferable that an inner wall portion on an outermost peripheral side in the radial direction of the second cam face portion is located on an outer peripheral side with respect to a moving trace of an innermost portion of the second moved member.

In accordance with an embodiment of the present invention, the surrounding wall part is formed in a ring shape over the entire periphery of the rotation cam body. Also in this structure, the size of the cam mechanism can be reduced.

In accordance with an embodiment of the present invention, the inner side cam face portion is arranged so that the second moved member is capable of passing between the inner side cam face portion and the outer side cam face. According to the cam mechanism in the embodiment of the present invention, the moving operation of the second moved member along the outer side cam face is not disturbed by the inner side cam face portion.

In accordance with an embodiment of the present invention, in order to make the first moved member move along both of the inner wall face of the protruding part and the inner wall portion of the recessed part, the first moved member is a shaft body which is disposed on one side in the turning center axial line direction of the rotation cam body and which is turnable around an axial line perpendicular to the turning center axial line direction or around an axial line parallel to the axial line, and the shaft body is urged toward a turning direction so as to be abutted with the inner side cam face around the axial line, and the shaft body is provided with a first abutting face, which is extended in the other side of the turning center axial line direction from the shaft body so as to be capable of abutting with the inner side cam face, and a second abutting face which is formed to be adjacent to the first abutting face on the other side in the turning center axial line direction so as to be capable of abutting with the second cam face portion. In this case, it is preferable that the inner side cam face portion which structures the inner side cam face is provided with bending wall parts that are formed by means of that ends of the protruding part sandwiching the discontinuity portion are bent to an outer peripheral side, and the second cam face portion which structures the inner side cam face is formed so that both end portions in a circumferential direction of the recessed part are continuously formed with an inner wall face of the bending wall part in the turning center axial line direction.

Next, according to at least an embodiment of the present invention, there may be provided an ice making device including the above-mentioned cam mechanism, an ice tray for manufacturing ice pieces, an ice storage part which stores the ice pieces, a scraping-out member which scrapes out the ice pieces from the ice tray to move the ice pieces to the ice storage part, ice detecting lever which is driven toward the ice storage part to detect an ice quantity in the ice storage part, and a switch whose output state is changed when the ice quantity in the ice storage part is sufficient. The scraping-out member is attached to the rotation cam body so that the scraping-out member is integrally turned with the rotation cam body, and the ice detecting lever is attached to the shaft body so that the ice detecting lever is integrally turned with the shaft body, and the second moved member is a lever for changing the output state of the switch.

According to the ice making device in this embodiment of the present invention, a drive mechanism for driving the scraping-out member which scrapes out ice pieces from the ice tray, the ice detecting lever which detects an ice quantity in the ice storage part, and a switch for detecting a position of the ice detecting lever can be structured smaller by means of that the above-mentioned cam mechanism is mounted on the drive mechanism and thus the size of the ice making device can be reduced.

In accordance with an embodiment of the present invention, the surrounding wall part is formed in a ring shape over the entire periphery of the rotation cam body. According to the ice making device in the embodiment of the present invention, the surrounding wall part is formed over the entire periphery of the rotation cam body and thus the scraping-out member attached to the rotation cam body can be turned more than one rotation. Therefore, ice pieces in the ice tray are surely moved to the ice storage part.

In accordance with an embodiment of the present invention, the first moved member is separated to an inner peripheral side from the inner side cam face when the ice quantity in the ice storage part is sufficient. According to the ice making device in the embodiment of the present invention, the inner side cam face is located on the inner side of the outer side cam face and thus, even when the first moved member is separated to the inner peripheral side from the inner side cam face, the first moved member is not interfered with the outer side cam face.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(A) is a perspective view showing an ice making device in accordance with an embodiment of the present invention which is viewed from a side where ice pieces are discharged, and FIG. 1(B) is a perspective view showing an ice making device in accordance with an embodiment of the present invention which is viewed from an opposite side to the side where ice pieces are discharged.

FIG. 2 is an exploded perspective view showing the ice making device which is viewed from an opposite side to the side where ice pieces are discharged.

FIG. 3 is a side view showing a drive unit in which an outer side housing is detached.

FIG. 4 is a horizontal sectional view showing the drive unit.

FIG. 5 is a plan view showing a side face on an opposite-to-output side of the rotation cam body.

FIG. 6(A) is a plan view showing an ice detecting shaft which is viewed from an upper side and FIG. 6(B) is a front view showing the ice detecting shaft which is viewed from a rotation cam body side.

FIG. 7 is a plan view showing a switch press lever which is viewed from an upper side.

FIG. 8 is a perspective view showing a rotation cam body, an ice detecting shaft and a switch press lever.

FIG. 9(A) is a longitudinal sectional view showing a state where an ice detecting shaft slides along a lever non-operating position part and where the rotation cam body and the ice detecting shaft are cut by a plane including the ice detecting shaft, and FIG. 9(B) is a longitudinal sectional view showing a state where the ice detecting shaft slides along an ice shortage detecting position part and where the rotation cam body and the ice detecting shaft are cut by the plane including the ice detecting shaft.

FIG. 10 is a flow chart showing an ice making operation of the ice making device.

FIG. 11(A) is a cam chart showing an initializing operation, FIG. 11(B) is a cam chart showing an operation when a quantity of stored ice pieces is insufficient, FIG. 11(C) is a cam chart showing an operation when a quantity of stored ice pieces is sufficient, and FIG. 11(D) is a cam chart showing a turning operation of an ice detecting shaft when a quantity of stored ice pieces is sufficient.

FIG. 12 is a plan view showing a rotation cam body which is mounted on a conventional ice making device.

### DETAILED DESCRIPTION OF THE PREFERRED EMBODIMENTS

An ice making device in accordance with an embodiment of the present invention will be described below with reference to the accompanying drawings.

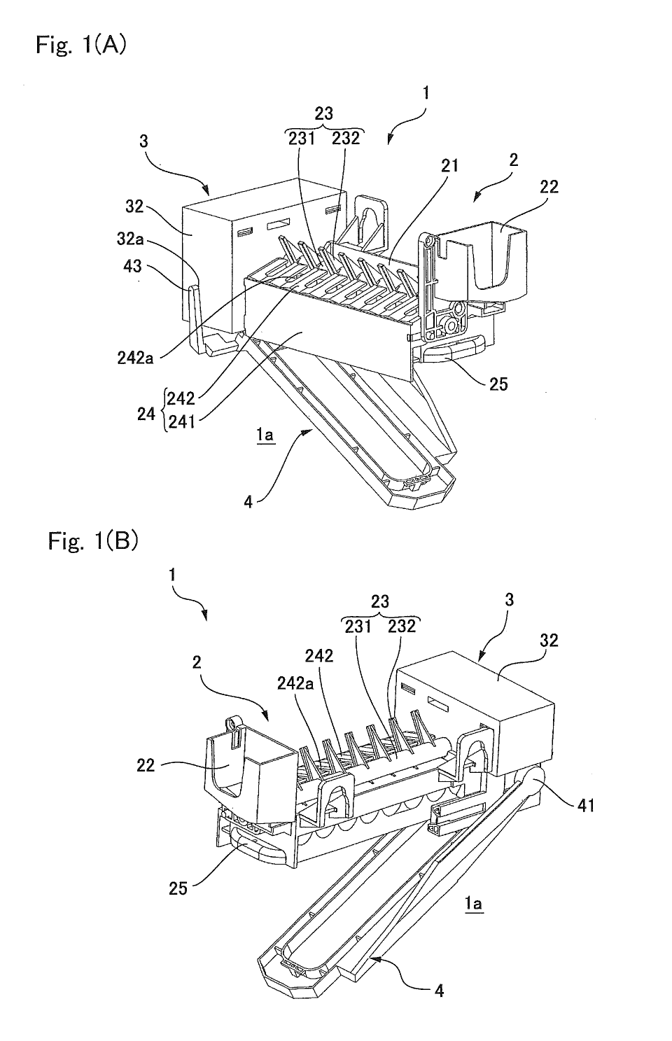

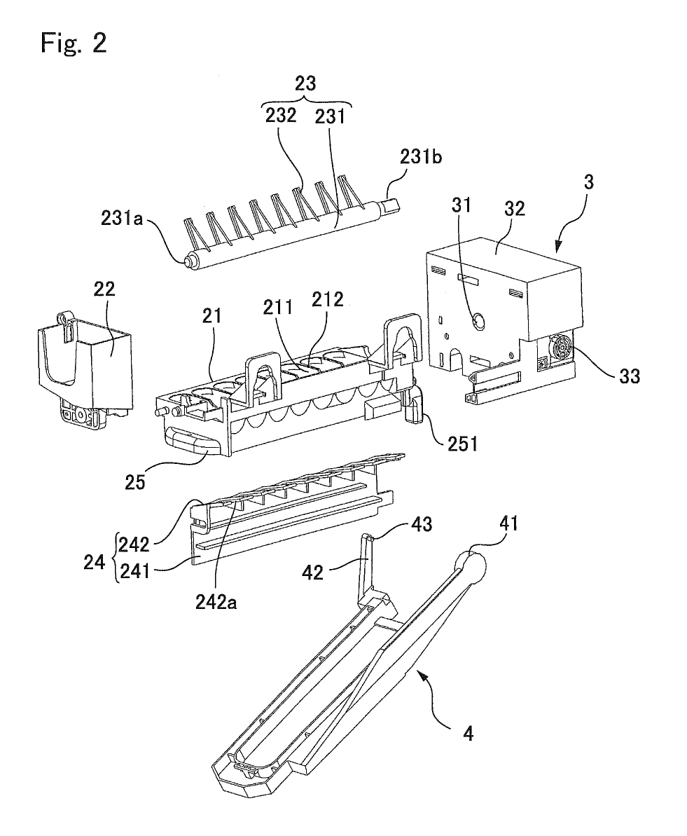

FIG. 1(A) is a perspective view showing an ice making device in accordance with an embodiment of the present invention which is viewed from a side where ice pieces are discharged, and FIG. 1(B) is a perspective view showing an ice making device in accordance with an embodiment of the present invention which is viewed from an opposite side to the side where ice pieces are discharged. FIG. 2 is an exploded perspective view showing the ice making device which is viewed from an opposite side to the side where ice pieces are discharged.

In an ice making device 1 in accordance with an embodiment of the present invention, ice pieces are successively manufactured in a refrigerator or a freezer and manufactured ice pieces are automatically discharged into an ice storage part 1a which is located on an under side of the ice making device 1. The ice making device 1 includes an ice making unit 2 for manufacturing ice pieces and a drive unit 3 which is disposed on one end side of the ice making unit 2. An ice detecting lever 4 for detecting an ice quantity stored in the ice storage part 1a is extended toward obliquely below on a lower side of the ice making unit 2 and the drive unit 3.

The ice making unit 2 includes an ice tray 21, a water-supply part 22 for supplying water in the ice tray 21, a scraping-out member 23 for moving ice pieces manufactured in the ice tray 21 to the ice storage part 1a, and a guide member 24.

The ice tray 21 is made of aluminum and is provided with surface treatment such as coating or alumite treatment. As shown in FIG. 2, a plurality of ice making grooves 212 are partitioned and formed on an upper face of the ice tray 21 through partitioning plates 211. Water supplied from the water-supply part 22 is stored in each of a plurality of the ice making grooves 212 to be frozen. A bottom face of the ice tray 21 is disposed with a heater 25 for heating the bottom face of the ice tray 21 when ice pieces are to be discharged from the ice tray 21. The heater 25 is integrated with the ice tray 21 by a method such as caulking. Terminals 251 for the heater 25 are protruded from the drive unit 3 side of the ice tray 21 and its face is formed with a temperature detected part (not shown) with which a thermostat for monitoring temperature is abutted.

The water-supply part 22 is disposed on an end part on an opposite side to the drive unit 3 of the ice making unit 2 so as to face the drive unit 3. A water-supply pipe is connected to the water-supply part 22 and a water-supply pump is connected with the water-supply pipe.

The scraping-out member 23 for scraping out ice pieces from the ice tray 21 includes a rotation shaft 231, which is extended in a right and left direction at an upper position of the ice tray 21, and a plurality of scraping-out parts 232 which is protruded in a pawl-like shape in the same direction from the rotation shaft 231. The scraping-out parts 232 correspond to the ice making grooves 212 in a one-to-one manner. An end portion on a water-supply part 22 side of the rotation shaft 231 is formed in a small diameter portion 231a, which is rotatably supported by a cut-out part formed at an edge part of a right side face of the ice tray 21 as a bearing. An end portion on a drive unit 3 side of the rotation shaft 231 is formed in a “D”-cut portion 231b, which is connected with the rotation cam body 31 disposed in the drive unit 3.

The guide member 24 guides ice pieces which are scraped out by the scraping-out member 23 to the ice storage part 1a located on an under side of the ice tray 21. The guide member 24 includes a rectangular side plate 241, which covers a side of the ice tray 21 where ice pieces are discharged, and an inclined plate 242 which is obliquely extended upward to the middle of the ice tray 21 from the upper end of the side plate 241. The inclined plate 242 is formed with a plurality of cut-out parts 242a so as to correspond to the scraping-out parts 232. Ice pieces which are scraped out from the ice tray 21 by the scraping-out member 23 are slid on the inclined plate 242 to be dropped to the ice storage part 1a.

The ice detecting lever 4 is formed in a “U”-shape as a whole. An open end portion 41 on its opening side is connected with the ice detecting shaft (shaft body) 33 which is exposed from a lower side portion of the side face of the drive unit 3 that is opposite to a side where the guide member 24 is disposed. The other open end portion 42 is formed to be bent upward and a protruded part 43 formed at an upper end portion is turnably fitted into a through hole 32a which is formed in a side face of a case 32 of the drive unit 3 on the side where the guide member 24 is disposed. The ice detecting shaft 33 is connected with the rotation cam body 31 which is disposed in the drive unit 3.

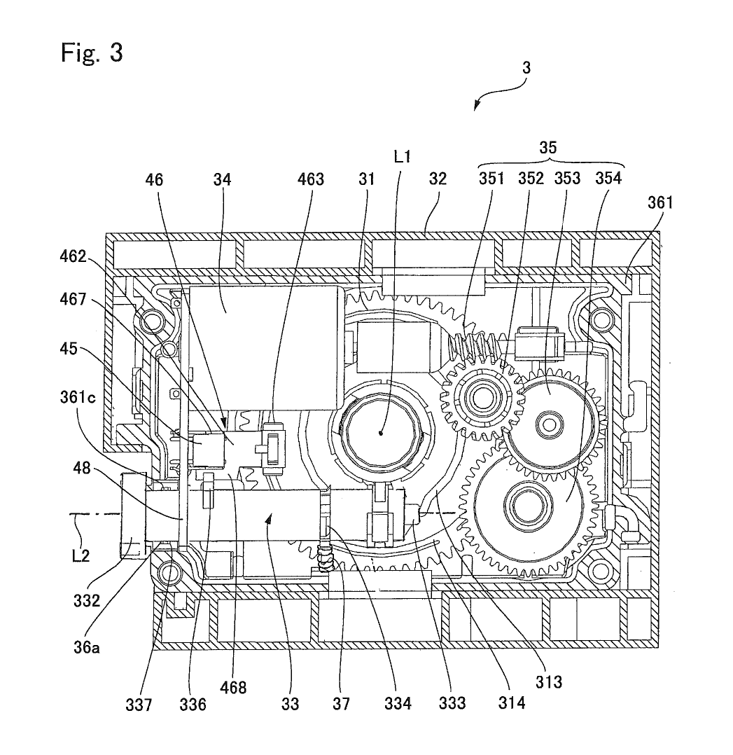

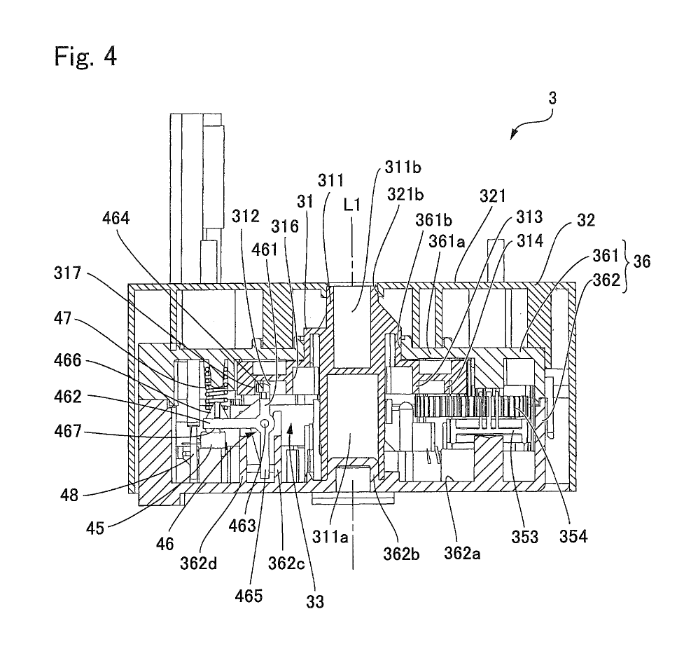

FIG. 3 is a side view showing the drive unit in which an outer side housing is detached. FIG. 4 is a horizontal sectional view showing the drive unit.

The drive unit 3 moves the ice detecting lever 4 downward and, based on its moving-down distance, it is detected whether ice pieces in the ice storage part 1a is sufficient or not. Further, when it is detected that an ice quantity in the ice storage part 1a is insufficient, the scraping-out member 23 is turned to scrape out manufactured ice pieces from the ice tray 21 to drop them in the ice storage part 1a.

As shown in FIG. 3, the drive unit 3 includes the rotation cam body 31, a DC motor 34 which is a drive source for the rotation cam body 31, a deceleration gear train 35 for transmitting a rotation output from the DC motor 34 to the rotation cam body 31, a housing 36 which accommodates these members in its inside, and a case 32 which covers the housing 36 from the ice making unit 2 side.

The deceleration gear train 35 includes a warm 351 connected with an output shaft of the DC motor 34, a first gear 352, a second gear 353 and a third gear 354. The housing 36 includes an inner side housing 361 which is disposed on an ice making unit 2 side and an outer side housing 362 which is disposed on an opposite side to the ice making unit 2 side. The housing 36 is structured by means of that edge parts of the inner side housing 361 and the outer side housing 362 are superposed on each other. The first gear 352, the second gear 353 and the third gear 354 are sandwiched by the inner side housing 361 and the outer side housing 362 to be rotatably supported. The case 32 is formed in a cup shape and is fitted from an ice making unit 2 side so as to cover side face portions of the inner side housing 361 and the outer side housing 362.

The rotation cam body 31 functions as an ice discharging mechanism for turnably driving the scraping-out member 23, an ice detecting mechanism for swingably driving the ice detecting lever 4, and a part of switch mechanism for turnably driving the switch press lever which presses a tact switch for detecting a position of the ice detecting lever 4.

As shown in FIG. 4, the rotation cam body 31 is integrally molded with an output shaft 311 which is coaxially extended with the turning center axial line “L1” of the rotation cam body 31.

An output side of the output shaft 311 is protruded toward an outer side of the housing 36 from a housing side output shaft through hole 361b which is provided in an end plate portion 361a on an ice making unit 2 side of the inner side housing 361. An end portion on an output side of the output shaft 311 is inserted into a case side output shaft through hole 321b which is provided in an end plate portion 321 on the ice making unit 2 side of the case 32 in a coaxial state with the housing side output shaft through hole 361b. An opposite-to-output side of the output shaft 311 is formed in a hollow shape and a protruded part 362b which is formed so as to protrude to an inner side from an end plate portion 362a of the outer side housing 362 is inserted into the hollow portion 311a. The output shaft 311 and the rotation cam body 31 are turnably supported by the housing side output shaft through hole 361b and the protruded part 362b. Further, an output side portion of the output shaft 311 is formed with a recessed part 311b into which the “D”-cut portion 231b of the rotation shaft 231 of the scraping-out member 23 is coaxially fitted. The “D”-cut portion 231b of the rotation shaft 231 of the scraping-out member 23 is inserted into the recessed part 311b so that the rotation shaft 231 of the scraping-out member 23 and the rotation cam body 31 are connected with each other. Therefore, the scraping-out member 23 and the rotation cam body 31 are turned in an integral manner.

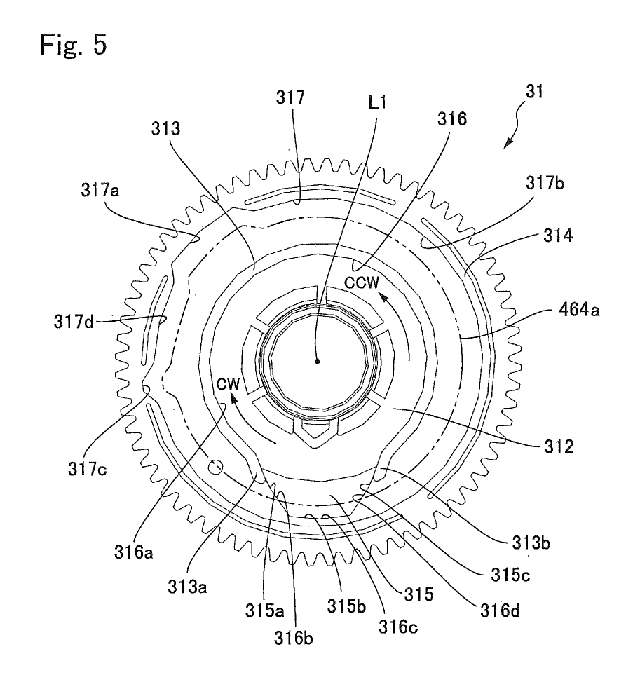

FIG. 5 is a plan view showing an end face 31a on an opposite-to-output side of the rotation cam body 31. A ring shaped recessed part 312 is formed on the end face 31a on the opposite-to-output side in the turning center axial line of the rotation cam body 31. A circular arc wall part (protruding part) 313 is formed in the recessed part 312 so as to stand up in substantially parallel to the turning center axial line “L1” of the rotation cam body 31 from a bottom face of the recessed part 312, and a ring-shaped wall part (surrounding wall part) 314 is formed on an outer peripheral side of the circular arc wall part 313 so as to stand up in substantially parallel to the turning center axial line “L1” of the rotation cam body 31 from the bottom face of the recessed part 312. Further, a hole part 315 penetrated in the axial direction is formed in an area sandwiched by a discontinuity portion between right and left ends of the circular arc wall part 313 and the ring-shaped wall part 314. The hole part 315 is formed in a roughly trapezoid shape and its opening is formed narrower toward the outer peripheral side. An ice detecting shaft cam face (inner side cam face) 316 is structured of an inner wall face of the circular arc wall part 313 (first cam face portion) and an inner wall portion directing to an inner side in the radial direction (second cam face portion) of the inner wall face of the hole part 315. A switch press lever cam face (outer side cam face) 317 is structured on an inner wall face of the ring-shaped wall part 314. The switch press lever cam face 317 is located on an outer peripheral side of the ice detecting shaft cam face 316.

The ice detecting shaft cam face 316 is a cam face for moving the ice detecting shaft 33 which turns the ice detecting lever 4 when the rotation cam body 31 is turned. The ice detecting shaft cam face 316 is continuously provided with a lever non-operating position part 316a, a lever moving down part 316b, an ice shortage detecting position part 316c, and a lever return operation part 316d in a counterclockwise direction (CCW direction). The lever non-operating position part 316a is a region for maintaining a state where the ice detecting lever 4 is not moved downward and is formed on the inner wall face of the circular arc wall part 313. The lever moving down part 316b is a region where the ice detecting lever 4 connected with the ice detecting shaft 33 is moved down to detect an ice quantity. The lever moving down part 316b is formed on the inner wall portion 315a which is located on one side in the circumferential direction of the hole part 315. In an edge portion on the inner peripheral side of the lever moving down part 316b, the inner wall portion 315a of the hole part 315 and an inner wall face of a bending wall part 313a which is formed bent toward the outer peripheral side from one end of the circular arc wall part 313 are continuously formed in the turning center axial line “L1” direction. In other words, in the hole part 315 which is the recessed part structuring the second cam face portion, the end portion on the inner peripheral side of the lever moving down part 316b which is one end portion of the hole part 315 in the circumferential direction, i.e., the end portion on the inner peripheral side of the inner wall portion 315a of the hole part 315, is continuously formed with the inner wall face of the bending wall part 313a in the turning center axial line “L1” direction. The ice detecting position part 316c is a region for maintaining a state where the ice detecting lever 4 has been moved to the lowest position when sufficient ice pieces are not stored in the ice storage part 1a. The ice detecting position part 316c is formed on the inner wall portion 315b on the outer peripheral side in the radial direction of the hole part 315. The lever return operation part 316d is a region for moving upward the ice detecting lever 4 which has been moved down and the lever return operation part 316d is formed on the other inner wall portion 315c in the circumferential direction of the hole part 315. In an end part on the inner peripheral side of the lever return operation part 316d, the inner wall portion 315c of the hole part 315 and the inner wall face of the bending wall part 313b which is formed bent toward the outer peripheral side from the other end portion of the circular arc wall part 313 are continuously formed in the turning center axial line “L1” direction. In other words, in the hole part 315 which is the recessed part structuring the second cam face portion, an end portion on the inner peripheral side of the lever return operation part 316d which is the other end portion of the hole part 315 in the circumferential direction, i.e., an end portion on the inner peripheral side of the inner wall portion 315c of the hole part 315, is also continuously formed with the inner wall face of the bending wall part 313b in the turning center axial line “L1” direction.

The switch press lever cam face 317 is a cam face for moving the switch press lever (second moved member) 46 which presses a tact switch 45 described below when the rotation cam body 31 is turned. The switch press lever cam face 317 is formed over the entire periphery of the ring-shaped wall part 314.

The switch press lever cam face 317 is continuously provided with a first signal generating cam part 317a, a first no-signal generating cam part 317b, a second signal generating cam part 317c and a second no-signal generating cam part 317d in a clockwise direction (CW direction). The first signal generating cam part 317a and the second signal generating cam part 317c are formed to recess toward the outer peripheral side respectively. The first signal generating cam part 317a is a region where, in a state that the ice making device 1 is making ice pieces, the switch press lever 46 is turned to press the tact switch and an “ON” signal is outputted from the tact switch. The first no-signal generating cam part 317b is a region for setting the tact switch in an “OFF” state during an ice discharging state where ice pieces are being scraped out from the ice tray 21. The second signal generating cam part 317c is a region where, in an ice detecting state when the ice detecting lever 4 is to be moved downward, the switch press lever 46 may be turned to press the tact switch to output an “ON” signal from the tact switch 45. The second no-signal generating cam part 317d is a region for setting the tact switch 45 in an “OFF” state when the ice making device 1 is returned to a waiting state from the ice detecting state.

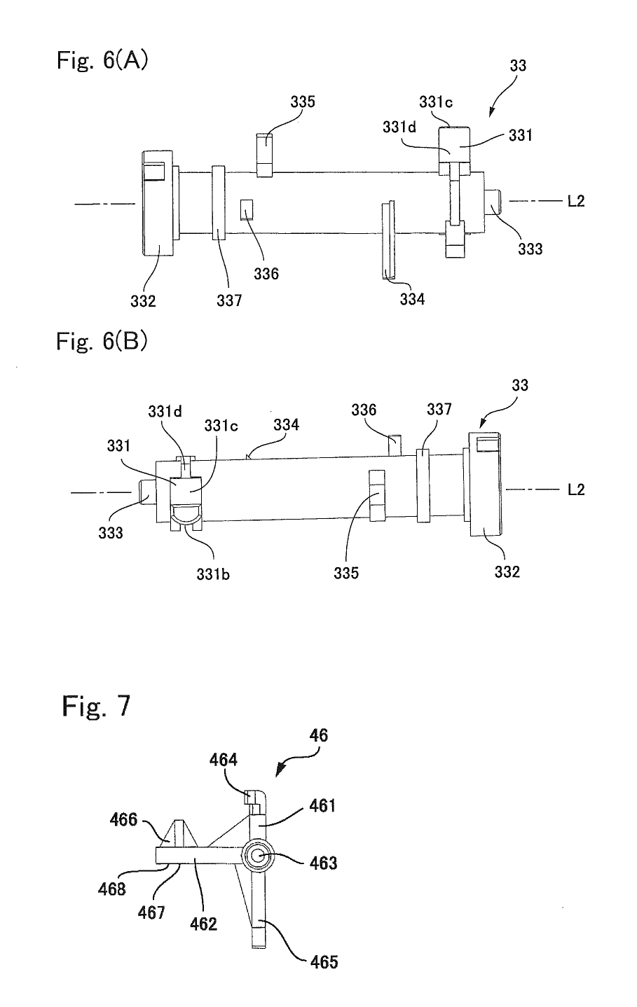

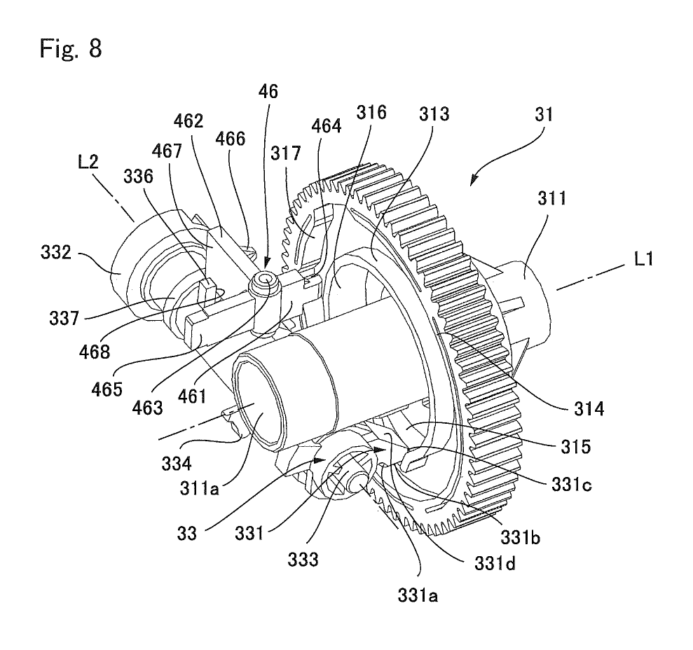

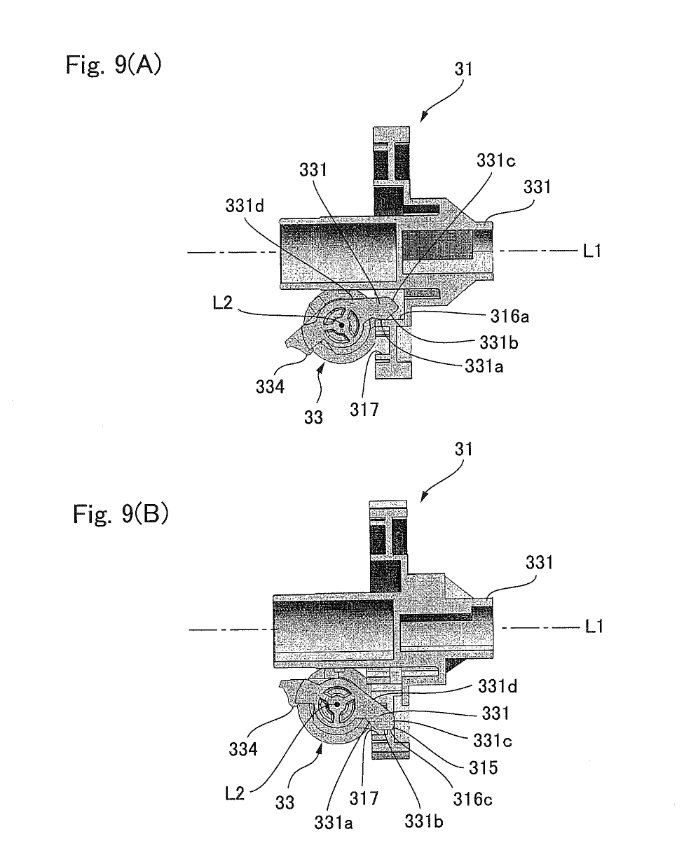

An ice detecting mechanism will be described below with reference to FIG. 3 through FIG. 9(B). FIG. 6(A) is a plan view showing the ice detecting shaft which is viewed from an upper side and FIG. 6(B) is a front view showing the ice detecting shaft which is viewed from the rotation cam body side. FIG. 7 is a plan view showing the switch press lever which is viewed from an upper side. FIG. 8 is a perspective view showing the rotation cam body, the ice detecting shaft and the switch press lever. FIG. 9(A) is a longitudinal sectional view showing a state where the ice detecting shaft is moving along the lever non-operating position part and where the rotation cam body and the ice detecting shaft are cut by a plane including the ice detecting shaft, and FIG. 9(B) is a longitudinal sectional view showing a state where the ice detecting shaft is moving along an ice shortage detecting position part and where the rotation cam body and the ice detecting shaft are cut by the plane including the ice detecting shaft.

The ice detecting mechanism 11 includes the rotation cam body 31, the ice detecting shaft (first moved member) 33 which is moved along the ice detecting shaft cam face 316, and a coiled spring 37 (see FIG. 3) which urges a slide part 331 structured in the ice detecting shaft 33 toward a turning direction around a center axial line “L2” of the ice detecting shaft 33 so as to abut with the ice detecting shaft cam face 316.

The ice detecting shaft 33 is penetrated through an ice detecting shaft through hole 36a, which is formed in a side plate portion of the housing 36, to be extended from the outside of the drive unit 3 to the inside of the housing 36. The ice detecting shaft 33 is horizontally disposed so that its center axial line “L2” is in parallel with an axial line which is perpendicular to the turning center axial line “L1” of the rotation cam body 31. More specifically, the center axial line “L2” of the ice detecting shaft 33 is located between the lever non-operating position part 316a of the ice detecting shaft cam face 316 and the ice detecting position part 316c in the radial direction in the lower half portion of the rotation cam body 31.

One end portion of the ice detecting shaft 33 which is exposed to the outside of the drive unit 3 is formed with a lever connecting part 332 having a large diameter to which the open end portion 41 of the ice detecting lever 4 is fitted. A case support part 333 having a small diameter is formed on the other end portion of the ice detecting shaft 33 which is located within the drive unit 3. The case support part 333 is turnably supported by a bearing part (not shown) which is formed to protrude to the inside of the housing 36 from the outer side housing 362.

As shown in FIG. 6(A), an outer peripheral face of the ice detecting shaft 33 is formed with, from a case support part 333 side, a slide part 331, a spring engagement part 334, a guide piece 335, a switch pressing prevention part 336 and a thrust detachment preventing protruded part 337 between the lever connecting part 332 and the case support part 333.

As shown in FIG. 6(A) through FIG. 9(B), the slide part 331 is protruded toward the rotation cam body 31 side from an outer peripheral face portion in the vicinity of the case support part 333 of the ice detecting shaft 33 in the turning center axial line “L1” direction. The slide part 331 is formed so that its tip end side is narrowed. The slide part 331 is provided with a first abutting face 331a, which is extended to the rotation cam body 31 side from the ice detecting shaft 33 and is capable of abutting with the inner wall face of the circular arc wall part 313, and a second abutting face 331b which is extended so as to be bent upward at an obtuse angle from an end on the rotation cam body 31 side of the first abutting face 331a and is capable of abutting with the inner wall portion directing to the inner side in the radial direction of the hole part 315. Further, the slide part 331 is provided with an end face 331c which is extended in a direction perpendicular to the second abutting face 331b from an end on an outer side of the second abutting face 331b, and a connecting face 331d which connects the end face 331c with an outer peripheral face of the ice detecting shaft 33. The first abutting face 331a and the second abutting face 331b are formed in curved faces. More specifically, the first abutting face 331a is formed so as to curve around an axial line which is parallel to the turning center axial line “L1” in an abutted state with the lever non-operating position part 316a of the inner wall face of the circular arc wall part 313. The second abutting face 331b is formed so as to curve around an axial line which is parallel to the turning center axial line “L1” in an abutted state with the ice detecting position part 316c of the inner wall portion of the hole part 315.

In this embodiment, as shown in FIGS. 9(A) and 9(B), when the ice detecting shaft 33 is moved along the ice detecting shaft cam face 316, the slide part 331 is displaced in the radial direction of the rotation cam body 31 depending on a turning angle of the rotation cam body 31 and thus the ice detecting shaft 33 is turned with this displacement. Further, depending on the turning angle of the ice detecting shaft 33, the abutting face of the slide part 331 with the ice detecting shaft cam face 316 is changed from the first abutting face 331a to the second abutting face 331b.

More specifically, while the slide part 331 slides on the lever non-operating position part 316a of the ice detecting shaft cam face 316, the first abutting face 331a is abutted with the lever non-operating position part 316a. When the slide part 331 slides on the lever moving down part 316b, the slide part 331 is displaced to the lower side in the radial direction of the rotation cam body 31 and thus the ice detecting shaft 33 is turned. As a result, the abutting part with the lever moving down part 316b is shifted from the first abutting face 331a to the second abutting face 331b. Next, while the slide part 331 slides on the ice detecting position part 316c, the second abutting face 331b is abutted with the ice detecting position part 316c. In this case, the ice shortage detecting position part 316c is provided on the outer peripheral side of a moving trace 464a of the innermost portion of the slide part 464 of the switch press lever 46. Therefore, the second abutting face 331b of the slide part 331 is moved to the outer side with respect to the moving trace 464a of the slide part 464 of the switch press lever 46. Next, when the slide part 331 slides on the lever return operation part 316d, the slide part 331 is displaced to the upper side in the radial direction of the rotation cam body 31 and thus the ice detecting shaft 33 is turned. As a result, the abutting part with the lever return operation part 316d is shifted from the second abutting face 331b to the first abutting face 331a.

The spring engagement part 334 is protruded from an outer peripheral face portion on an opposite side to the slide part 331 across the center axial line “L2”. The spring engagement part 334 is engaged with an upper end opening of the coiled spring 37 which is disposed between the spring engagement part 334 and a bottom plate (not shown) of the outer side housing 362. The coiled spring 37 is disposed in a compressed state and the ice detecting shaft 33 is urged in the turning direction around the center axial line “L2” by a restoring force of the coiled spring 37 so that the slide part 331 is pressed against the ice detecting shaft cam face 316.

The guide piece 335 is protruded in a direction perpendicular to the center axial line “L2” from the outer peripheral face of the ice detecting shaft 33. The guide piece 335 is fitted into a guide groove (not shown) which is formed in the inner side housing 361 to be moved along the guide groove. As a result, the ice detecting shaft 33 is turned without moving in the thrust direction.

The switch pressing prevention part 336 structures a part of the switch mechanism, which will be described in detail below, and is protruded to an outer side from the outer peripheral face portion between the lever connecting part 332 and the spring engagement part 334. When the ice detecting shaft 33 is turned over a predetermined angular range by means of that the slide part 331 is displaced to the lower side, the switch pressing prevention part 336 is abutted with the switch press lever 46 to prevent the switch press lever 46 from turning.

The thrust detachment preventing protruded part 337 is a ring-shaped protruded part which is formed over the entire periphery of the outer peripheral face of the ice detecting shaft 33. The thrust detachment preventing protruded part 337 is inserted into a circular arc groove 361c, which is formed at an edge portion of the ice detecting shaft through hole 36a in the inner side housing 361, and a circular arc groove (not shown) which is formed at an edge portion of the ice detecting shaft through hole 36a in the outer side housing 362 so that the ice detecting shaft 33 is not detached from the housing 36.

When the rotation cam body 31 is turned, the slide part 331 slides along the ice detecting shaft cam face 316 and the ice detecting shaft 33 is turned in a predetermined angular range. When the ice detecting shaft 33 is turned, the ice detecting lever 4 attached to the ice detecting shaft 33 is swung in a predetermined angular range with the center axial line “L2” of the ice detecting shaft 33 as a turning center.

Next, the switch mechanism will be described with reference to FIGS. 3 through 8. The switch mechanism 12 includes the rotation cam body 31, the switch press lever 46 moving along the switch press lever cam face 317, the tact switch 45 whose “ON” and “OFF” states are changed by turning of the switch press lever 46, the coiled spring 47 which applies an urging force for turning the switch press lever 46, and the switch pressing prevention part 336 which is formed on the ice detecting shaft 33.

As shown in FIG. 7, the switch press lever 46 is formed in a “T” shape when viewed from an upper side. The switch press lever 46 is provided with a cam side extended part 461 which is extended in the turning center axial line “L1” direction of the rotation cam body 31, and a switch side extended part 462 which is extended in a direction perpendicular to the cam side extended part 461 from a midway of the cam side extended part 461. Further, the switch press lever 46 is supported by a lever support part (not shown), which is protruded within the housing 36 from the outer side housing 362, at a crossing portion 463 of the cam side extended part 461 and the switch side extended part 462 in a turnable state with an axial line extended in an upper and lower direction as a turning center. The crossing portion 463 of the cam side extended part 461 and the switch side extended part 462 is located on an upper side of the ice detecting shaft 33.

A tip end portion of the cam side extended part 461 which is inserted in the recessed part 312 of the rotation cam body 31 is a slide part 464 which is slid on the switch press lever cam face 317. A rear end side of the cam side extended part 461 is a turning restricting part 465 which restricts a turning range of the switch press lever 46. The turning restricting part 465 is disposed between a wall part 362c and a wall part 362d which are protruded within the housing 36 in parallel to each other from an end plate portion 362a of the outer side housing 362. The turning range of the switch press lever 46 is restricted by means of that the turning range of the turning restricting part 465 is restricted by the wall part 362c and the wall part 362d.

A face on the rotation cam body 31 side of the switch side extended part 462 is formed with a spring engagement part 466 which is protruded toward the rotation cam body 31 side. A face of the switch side extended part 462 on an opposite side to the rotation cam body 31 faces a button of the tact switch 45, and a pressed part 467 which is abutted with the tact switch 45 is formed on this face. Further, the face is formed with an abutting part 468 with which the switch pressing prevention part 336 provided in the ice detecting shaft 33 is capable of abutting.

The spring engagement part 466 is engaged with one of opening ends of the coiled spring 47 which is disposed between the spring engagement part 466 and the end plate portion 361a of the inner side housing 361. The coiled spring 47 is disposed in a compressed state and the switch press lever 46 is urged so that its slide part 464 is pressed against the switch press lever cam face 317 of the rotation cam body 31 by the restoring force of the coiled spring 47.

The tact switch 45 is fixed to the outer side housing 362 and connected with a printed circuit board 48 which is connected with a rear end of the DC motor 34.

When the switch press lever 46 is moved along the first signal generating cam part 317a of the switch press lever cam face 317, depending on a turning angle of the rotation cam body 31, the switch press lever 46 is turned in a direction that the tip end side of the cam side extended part 461 is separated from the turning center axial line “L1” of the rotation cam body 31. As a result, the pressed part 467 presses the tact switch 45 to output an “ON” signal from the tact switch 45. When the switch press lever 46 is moved along the first no-signal generating cam part 317b, the switch press lever 46 is turned in a direction that the tip end side of the cam side extended part 461 comes near to the turning center axial line “L1” of the rotation cam body 31. As a result, since the pressed part 467 is separated from the tact switch 45, the tact switch 45 is turned in an “OFF” state. When the switch press lever 46 is moved along the second signal generating cam part 317c, the switch press lever 46 is turned in a direction that the tip end side of the cam side extended part 461 is separated from the turning center axial line “L1” of the rotation cam body 31. As a result, since the pressed part 467 presses the tact switch 45, an “ON” signal is outputted from the tact switch 45. When the switch press lever 46 is moved along the second no-signal generating cam part 317d, the switch press lever 46 is turned in a direction that the tip end side of the cam side extended part 461 comes near to the turning center axial line “L1” of the rotation cam body 31. As a result, since the pressed part 467 is separated from the tact switch 45, the tact switch 45 is turned in an “OFF” state.

In this embodiment, in the state where the switch pressing prevention part 336 is abutted with the abutting part 468, even when the switch press lever 46 is going to move along the second signal generating cam part 317c of the switch press lever cam face 317, the turning of the switch press lever 46 is prevented. As a result, the slide part 464 of the switch press lever 46 is unable to slide along the second signal generating cam part 317c and thus the switch press lever 46 does not press the tact switch 45. Therefore, in this case, the “OFF” state of the tact switch 45 is maintained.

In the ice detecting state where the ice detecting lever 4 is moved down, the state that the switch pressing prevention part 336 is abutted with the abutting part 468 is a state that ice pieces in the ice storage part 1a is not stored more than a predetermined quantity or that ice pieces are in an insufficient state. In this state, moving down of the ice detecting lever 4 is not disturbed by ice pieces in the ice storage part 1a. Therefore, turning of the ice detecting shaft 33 is not disturbed when the slide part 331 is displaced to the lower side and thus the ice detecting shaft 33 is turned more than a predetermined angular range. As a result, the tact switch 45 is held in the “OFF” state. In this embodiment, the ice detecting shaft 33 is turned in an angular range from zero degree to 35 degrees depending on the turning angle of the rotation cam body 31. When the ice detecting shaft 33 is turned more than 30 degrees, the abutting part 468 and the switch pressing prevention part 336 are abutted with each other.

In this embodiment, as shown in FIG. 5, the moving trace 464a of the innermost portion in the radial direction of the slide part 464 of the switch press lever 46 is located in an area between the circular arc wall part (protruding part) 313 and the switch press lever cam face 317. The moving trace 464a is overlapped with an outer peripheral side portion of the lever moving down part 316b of the ice detecting shaft cam face 316, the ice shortage detecting position part 316c, and an outer peripheral side portion of the lever return operation part 316d. Therefore, like a conventional example, when the lever moving down part 316b of the ice detecting shaft cam face 316, the ice shortage detecting position part 316c, and the lever return operation part 316d are formed on the inner wall face of the protruding part which is protruded from the recessed part 312 of the rotation cam body 31, the protruding part and the switch press lever 46 are interfered with each other and thus the rotation cam body 31 is unable to turn over one rotation around the turning center axial line “L1”.

On the other hand, in this embodiment, the outer peripheral side portion of the lever moving down part 316b of the ice detecting shaft cam face 316, the ice shortage detecting position part 316c, and the outer peripheral side portion of the lever return operation part 316d are formed on the inner wall part of the hole part 315 and thus the protruding part is not structured on the moving trace 464a of the slide part 464 of the switch press lever 46. In addition, a distance between the ice detecting shaft cam face 316 including the bending wall part 313a and the switch press lever cam face 317 is set so that the slide part 331 is capable of passing through. Further, the position in the radial direction of the ice shortage detecting position part 316c, in other words, the inner wall portion of the outermost peripheral side in the radial direction of the inner wall portion (second cam face portion) of the hole part 315, is located on the outer peripheral side with respect to the moving trace 464a of the innermost portion of the switch press lever 46 which is the second moved member. As a result, the slide part 464 of the switch press lever 46 is capable of passing through the opening of the hole part 315 where the ice detecting shaft cam face 316 is formed. Therefore, a space for passing the slide part 464 of the switch press lever 46 is not required on the outer peripheral side of the ice detecting shaft cam face 316 in order that the rotation cam body 31 is turned over one rotation around the turning center axial line “L1”. Further, the slide part 464 of the switch press lever 46 is slid on the inner wall face of the switch press lever cam face 317 and thus the slide part 464 is not interfered with the opening of the hole part 315 which is formed in the axial direction. Accordingly, the switch press lever cam face 317 can be structured at a closer position to the turning center axial line “L1” of the rotation cam body 31. Further, the switch press lever 46 can be disposed at a closer position to the turning center axial line “L1” of the rotation cam body 31. Therefore, the size of the cam mechanism can be reduced. Further, since the cam mechanism structured as described above is utilized, a mechanism for driving the scraping-out member 23 which scrapes out ice pieces from the ice tray 21, the ice detecting lever 4 which detects an ice quantity in the ice storage part 1a, and the tact switch 45 which detects the position of the ice detecting lever 4 can be structured smaller, the size of the ice making device 1 can be reduced.

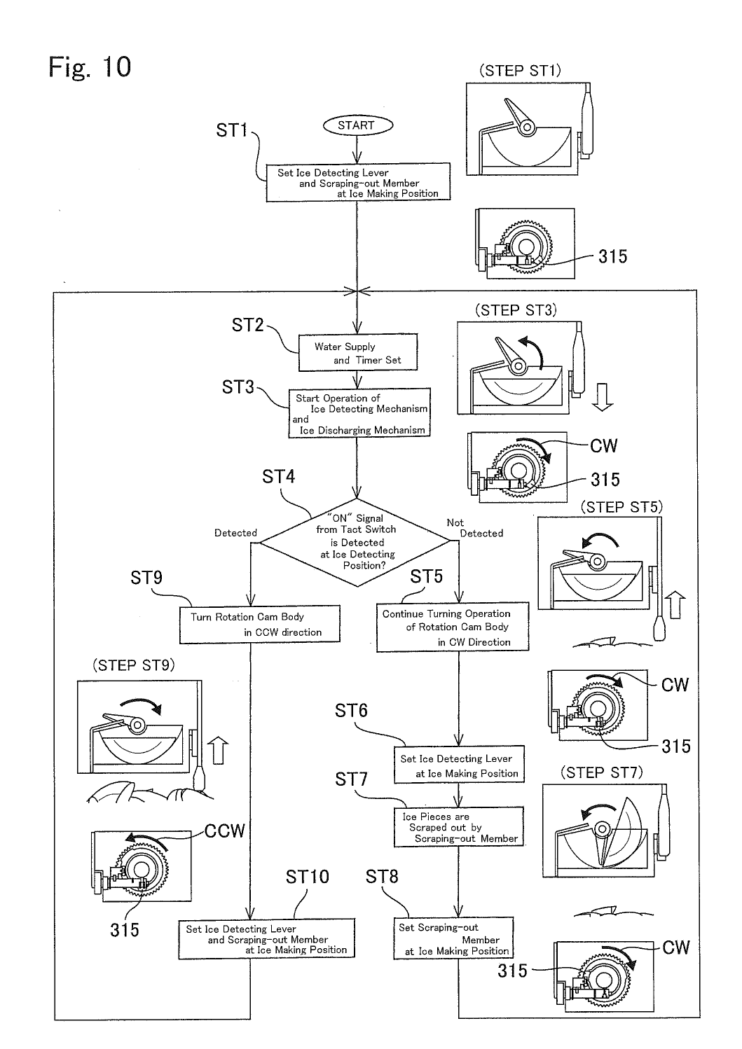

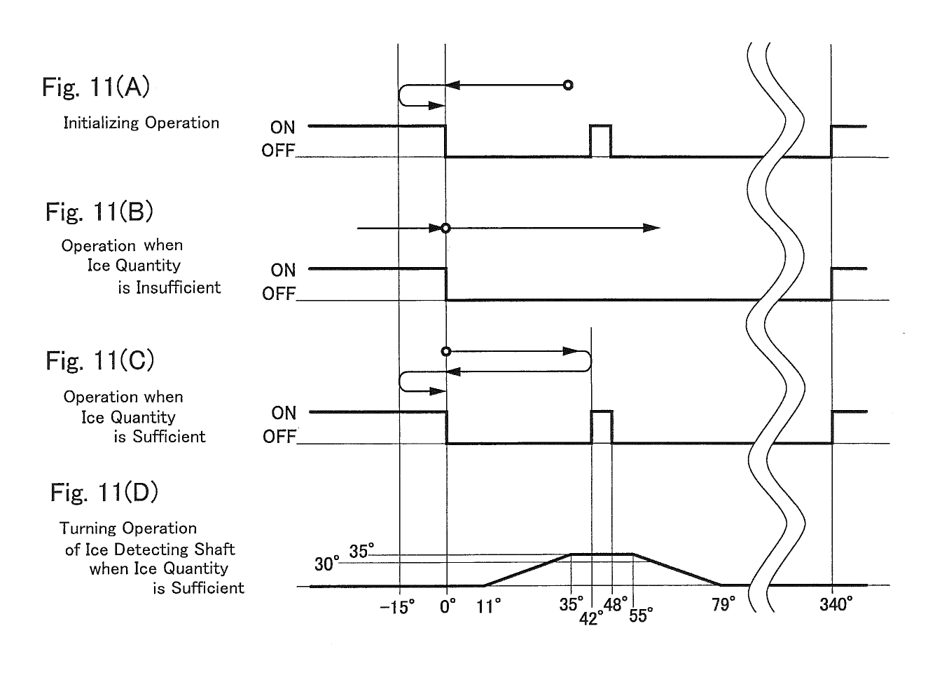

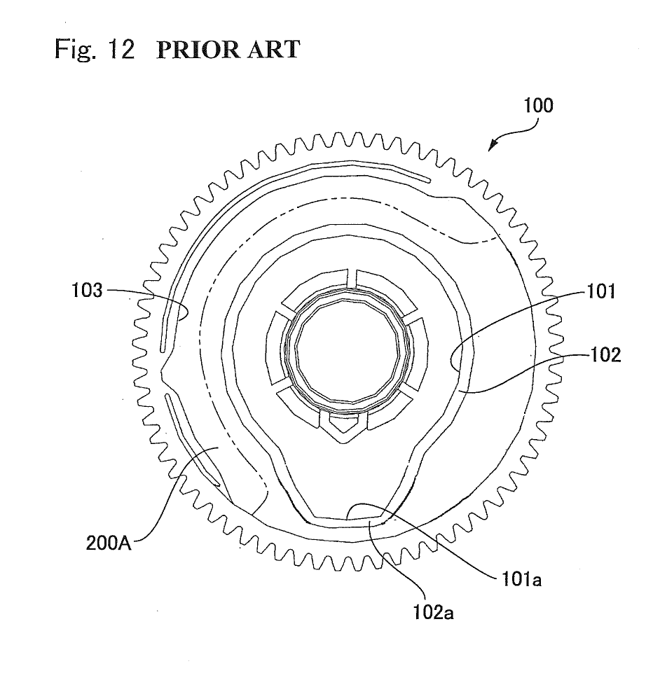

FIG. 10 is a flow chart showing an ice making operation of the ice making device 1. Views inserted in the flow chart in FIG. 10 are as follows. An upper side view shows positions of the scraping-out member 23 and the ice detecting lever 4 in a corresponding step, and a lower side view shows a state of the cam mechanism in the corresponding step. The upper side view is a view showing the ice making device 1 which is viewed from the ice making unit 2 side, and the lower side view is a view showing the ice making device 1 which is viewed from the drive unit 3 side. FIG. 11(A) is a cam chart showing an initializing operation, FIG. 11(B) is a cam chart showing an operation when a quantity of stored ice pieces is insufficient or in a shortage state, FIG. 11(C) is a cam chart showing an operation when a quantity of stored ice pieces is sufficient, and FIG. 11(D) is a cam chart showing a turning operation of the ice detecting shaft when a quantity of stored ice pieces is sufficient.

Drive of the ice making device 1 is controlled by a control section (not shown). The control section may be provided in the ice making device 1 but may be structured as a part of a control section for a refrigerator to which the ice making device 1 is attached.

When either of an “ON” signal for a power supply and an initializing signal is inputted into the control section, the control section executes an initializing operation where the ice detecting lever 4 and the scraping-out member 23 are set to be at the ice making position (step “ST1”).

In the initializing operation, the control section drives the DC motor 34 in the CCW direction to turn the rotation cam body 31 in the counterclockwise direction (CCW direction) and, when a predetermined time period has passed after an “ON” signal is detected, the DC motor 34 is stopped. The rotation cam body 31 is stopped at the position of −15 degrees from the home position (zero degree) through this operation.

Next, the control section drives the DC motor 34 in the CW direction to turn the rotation cam body 31 in the clockwise direction (CW direction) until the switch press lever 46 is moved along the second no-signal generating cam part 317d to turn the tact switch 45 in an “OFF” state. In this manner, the rotation cam body 31 is set in a stopped state at the home position and the ice detecting lever 4 and the scraping-out member 23 are set at the ice making position.

At the ice making position, the ice detecting lever 4 is set to be a substantially horizontal state. The scraping-out part 232 is set in an inclined state toward a side where the guide member 24 is disposed. The slide part 331 of the ice detecting shaft 33 is abutted with the lever non-operating position part 316a and the slide part 464 of the switch press lever 46 is abutted with the second no-signal generating cam part 317d (views in the step “ST1”).

When the initializing operation has ended, water supply to the ice tray 21 is performed and a timer is set (step “ST2”).

When a predetermined time period set in the timer has passed or, when it is judged through a thermostat that water in the ice tray 21 has become ice pieces, the control section drives the DC motor 34 in the CW direction to operate the ice detecting mechanism and the ice discharging mechanism (step “ST3”). More specifically, the rotation cam body 31 is turned in the clockwise direction (CW direction) to turn the scraping-out member 23 toward the guide member 24 side. In this embodiment, the slide part 331 slides on the lever moving down part 316b from a position where the rotation cam body 31 has turned by 11 degrees from the home position. Therefore, the ice detecting shaft 33 begins to turn and the ice detecting lever 4 begins to move down.

When the rotation cam body 31 is further turned in the clockwise direction (CW direction) and has reached to the ice detecting position where the rotation cam body 31 is turned by 42 degrees from the home position, the control section judges whether an “ON” signal is outputted from the tact switch 45 or not (step “ST4”). In the ice detecting position, the slide part 464 of the switch press lever 46 has reached to the position where the slide part 464 is capable of abutting with the second signal generating cam part 317c.

In the step “ST4”, when ice pieces are stored in the ice storage part 1a insufficiently, the moving down of the ice detecting lever 4 is not disturbed by ice pieces in the ice storage part 1a. Therefore, the ice detecting lever 4 is moved down to the lowest position and the ice detecting shaft 33 is moved along the ice shortage detecting position part 316c. More specifically, the slide part 331 of the ice detecting shaft 33 slides on the ice shortage detecting position part 316c in an angular range from 35 degrees to 55 degrees.

In the state where the slide part 331 of the ice detecting shaft 33 slides on the ice shortage detecting position part 316c, the slide part 331 is displaced to the lowest position and the ice detecting shaft 33 is turned more than the predetermined angular range. Therefore, the abutting part 468 of the switch press lever 46 is abutted with the switch pressing prevention part 336 of the ice detecting shaft 33. Accordingly, even when the switch press lever 46 is going to abut with the second signal generating cam part 317c of the switch press lever cam face 317, the turning of the switch press lever 46 is prevented. As a result, since the switch press lever 46 is not moved along the second signal generating cam part 317c, the switch press lever 46 does not press the tact switch 45. Therefore, the tact switch 45 is maintained in the “OFF” state.

In this embodiment, when an “ON” signal is not outputted from the tact switch 45 after the DC motor 34 is driven in the CW direction and before the predetermined time period has passed, the control section supplies an electric current to the heater 25 and thus the ice tray 21 is heated. When the predetermined time period set in the timer has passed, or it is judged through the thermostat that surfaces of ice pieces contacting with the ice tray 21 have melted, the control section stops energization to the heater 25 and drives the DC motor 34 in the CW direction to continue the turning operation of the rotation cam body 31 in the clockwise direction (CW direction) (step “ST5”).

Ice pieces in the ice tray 21 are turned along the inner face of the ice tray 21 in the CCW direction by the scraping-out member 23 through driving in the CW direction of the DC motor 34. When turning of the ice pieces exceeds 180 degrees by further turning of the scraping-out member 23, upper faces of the ice pieces (water surface before freezing) in the ice tray 21 slide along the upper face of the scraping-out member 23 and the upper face of the inclined plate 242 and then the ice pieces are dropped to the ice storage part 1a.

When a predetermined time period has passed after an “ON” signal is detected from the tact switch 45 or, when an “OFF” signal is detected after an “ON” signal has been detected from the tact switch 45, the DC motor 34 is stopped and the rotation cam body 31 is returned to the home position. Specifically, after driving in the CW direction of the DC motor 34 has continued, when the rotation cam body 31 is turned by 340 degrees from the home position, the switch press lever 46 is moved along the first signal generating cam part 317a and an “ON” signal is outputted from the tact switch 45 and then, when the rotation cam body 31 is further turned by 20 degrees, an “OFF” signal is outputted from the tact switch 45. The control section drives the DC motor 34 in the CW direction only by a predetermined time period after the “ON” signal outputted from the tact switch 45 is detected or until an “OFF” signal from the tact switch 45 is detected. In this manner, the rotation cam body 31 is turned in the clockwise direction (CW direction) to return to the home position.

While the rotation cam body 31 is turned in the clockwise direction (CW direction) to return to the home position, the slide part 331 of the ice detecting shaft 33 slides along from the lever return operation part 316d to the lever non-operating position part 316a. Therefore, the ice detecting shaft 33 is turned in a direction so that the ice detecting lever 4 is moved upward and the ice detecting lever 4 is returned to the ice making position (step “ST6”). More specifically, while the slide part 331 slides on the lever return operation part 316d in an angular range from 55 degrees to 79 degrees, the ice detecting shaft 33 moves the ice detecting lever 4 upward so that the ice detecting lever 4 is returned to the ice making position.

Further, since the scraping-out parts 232 are returned to the ice making position through one rotation around the rotation shaft 231, ice pieces in the ice tray 21 are scraped out by the scraping-out parts 232 to be dropped to the ice storage part 1a before the scraping-out parts 232 are returned to the ice making position (steps “ST7” and “ST8”).

Next, in the step “ST4”, when the rotation cam body 31 is turned to the ice detecting position and, in this state, when an ice quantity stored in the ice storage part 1a is sufficient, moving downward of the ice detecting lever 4 is disturbed by ice pieces in the ice storage part 1a and thus the ice detecting lever 4 is not moved to the lowest position. As a result, the slide part 331 is not displaced to the lowest position and thus the ice detecting shaft 33 is not turned more than the predetermined angular range. Therefore, the switch pressing prevention part 336 of the ice detecting shaft 33 is not abutted with the abutting part 468 of the switch press lever 46 and thus the turning of the switch press lever 46 is not prevented. As a result, the slide part 464 of the switch press lever 46 slides on the second signal generating cam part 317c in an angular range from 42 degrees to 48 degrees and thus the switch press lever 46 presses the tact switch 45 to output an “ON” signal from the tact switch 45.

In this embodiment, when an “ON” signal is outputted from the tact switch 45 before a predetermined time period has passed after the DC motor 34 is driven in the CW direction, the control section turns the rotation cam body 31 in the counterclockwise direction (CCW direction) until a next “ON” signal from the tact switch 45 is detected. Further, the DC motor 34 is stopped when a predetermined time period has passed after the next “ON” signal is detected (step “ST9”). In this manner, the rotation cam body 31 is stopped at the position of −15 degrees from the home position. After that, the DC motor 34 is driven in the CW direction to turn the rotation cam body 31 in the clockwise direction (CW direction) and the switch press lever 46 is moved along the second no-signal generating cam part 317d until the tact switch 45 is turned in an “OFF” state. In this manner, the rotation cam body 31 is stopped at the home position, and the ice detecting lever 4 and the scraping-out member 23 are set at the ice making position (step “ST10”).

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A cam mechanism comprising:
a rotation cam body;
a first moved member which is urged toward an inner side cam face that is formed on the rotation cam body so as to move along the inner side cam face; and
a second moved member which is urged toward an outer side cam face that is formed on the rotation cam body so as to move along the outer side cam face;
wherein an end face located on one side in a turning center axial line direction of the rotation cam body is formed with:
a surrounding wall part which is protruded from the end face;
a protruding part which is protruded from the end face on an inner peripheral side with respect to the surrounding wall part so as to face the surrounding wall part and, a part of which is formed as a discontinuity portion; and
a recessed part which is formed so as to recess from the end face in an area sandwiched between the surrounding wall part and the discontinuity portion; and
wherein the outer side cam face is structured of an inner wall face of the surrounding wall part;
wherein the inner side cam face is structured of an inner side cam face portion formed of an inner wall face of the protruding part and a second cam face portion formed of an inner wall portion directing to an inner side in a radial direction of the recessed part; and
wherein at least the outer side cam face is located on an outer side of the second cam face portion.

2. The cam mechanism according to claim 1, wherein the surrounding wall part is formed in a ring shape over an entire periphery of the rotation cam body.

3. The cam mechanism according to claim 1, wherein the inner side cam face portion is arranged so that the second moved member is capable of passing between the inner side cam face portion and the outer side cam face.

4. The cam mechanism according to claim 3, wherein an inner wall portion on an outermost peripheral side in the radial direction of the second cam face portion is located on an outer peripheral side with respect to a moving trace of an innermost portion of the second moved member.

5. The cam mechanism according to claim 4, wherein
the inner side cam face portion which structures the inner side cam face is provided with bending wall parts that are formed by means of that ends of the protruding part sandwiching the discontinuity portion are bent to an outer peripheral side, and
the second cam face portion which structures the inner side cam face is formed so that both end portions in a circumferential direction of the recessed part are continuously formed with an inner wall face of the bending wall part in the turning center axial line direction.

6. The cam mechanism according to claim 1, wherein
the first moved member is a shaft body which is disposed on one side in the turning center axial line direction of the rotation cam body and which is turnable around an axial line perpendicular to the turning center axial line direction or around an axial line parallel to the axial line,
the shaft body is urged toward a turning direction so as to be abutted with the inner side cam face around the axial line, and
the shaft body is provided with a first abutting face, which is extended in the other side of the turning center axial line direction from the shaft body so as to be capable of abutting with the inner side cam face, and a second abutting face which is formed to be adjacent to the first abutting face on the other side in the turning center axial line direction so as to be capable of abutting with the second cam face portion.

7. The cam mechanism according to claim 6, wherein
an inner wall portion on an outermost peripheral side in the radial direction of the second cam face portion is located on an outer peripheral side with respect to a moving trace on an innermost portion of the second moved member, and
the second abutting face of the shaft body is structured to move to an outer peripheral side with respect to the moving trace of the second moved member when the second abutting face is abutted with the second cam face portion.

8. The cam mechanism according to claim 7, wherein
the inner side cam face portion which structures the inner side cam face is provided with bending wall parts that are formed by means of that ends of the protruding part sandwiching the discontinuity portion are bent to an outer peripheral side, and
the second cam face portion which structures the inner side cam face is formed so that both end portions in a circumferential direction of the recessed part are continuously formed with an inner wall face of the bending wall part in the turning center axial line direction.

9. An ice making device comprising:
a cam mechanism comprising:
a rotation cam body;
a first moved member which is urged toward an inner side cam face that is formed on the rotation cam body so as to move along the inner side cam face; and
a second moved member which is urged toward an outer side cam face that is formed on the rotation cam body so as to move along the outer side cam face;
wherein an end face located on one side in a turning center axial line direction of the rotation cam body is formed with:
a surrounding wall part which is protruded from the end face;
a protruding part which is protruded from the end face on an inner peripheral side with respect to the surrounding wall part so as to face the surrounding wall part and, a part of which is formed as a discontinuity portion; and
a recessed part which is formed so as to recess from the end face in an area sandwiched between the surrounding wall part and the discontinuity portion; and
wherein the outer side cam face is structured of an inner wall face of the surrounding wall part;
wherein the inner side cam face is structured of an inner side cam face portion formed of an inner wall face of the protruding part and a second cam face portion formed of an inner wall portion directing to an inner side in a radial direction of the recessed part;
wherein at least the outer side cam face is located on an outer side of the second cam face portion;
wherein the first moved member is a shaft body which is disposed on one side in the turning center axial line direction of the rotation cam body and which is turnable around an axial line perpendicular to the turning center axial line direction or around an axial line parallel to the axial line;
wherein the shaft body is urged toward a turning direction for abutting with the inner side cam face around the axial line; and
wherein the shaft body is provided with a first abutting face, which is extended in the other side of the turning center axial line direction from the shaft body so as to be capable of abutting with the inner side cam face, and a second abutting face which is formed to be adjacent to the first abutting face on the other side in the turning center axial line direction so as to be capable of abutting with the second cam face portion; and
an ice tray for manufacturing ice pieces;
an ice storage part which stores the ice pieces;
a scraping-out member which scrapes out the ice pieces from the ice tray to move the ice pieces to the ice storage part;
ice detecting lever which is driven toward the ice storage part to detect an ice quantity in the ice storage part; and
a switch whose output state is changed when the ice quantity in the ice storage part is sufficient;
wherein the scraping-out member is attached to the rotation cam body so that the scraping-out member is integrally turned with the rotation cam body;
wherein the ice detecting lever is attached to the shaft body so that the ice detecting lever is integrally turned with the shaft body; and
wherein the second moved member is a lever for changing the output state of the switch.

10. The ice making device according to claim 9, wherein the surrounding wall part is formed in a ring shape over an entire periphery of the rotation cam body.

11. The ice making device according to claim 9, wherein the shaft body is separated to an inner peripheral side from the inner side cam face when the ice quantity in the ice storage part is sufficient.

12. The ice making device according to claim 9, wherein
an inner wall portion on an outermost peripheral side in the radial direction of the second cam face portion is located on an outer peripheral side with respect to a moving trace on an innermost portion of the second moved member, and
the second abutting face of the shaft body is structured to move to an outer peripheral side with respect to the moving trace of the second moved member when the second abutting face is abutted with the second cam face portion.

13. The ice making device according to claim 12, wherein
the inner side cam face portion which structures the inner side cam face is provided with bending wall parts that are formed by means of that ends of the protruding part through the discontinuity portion are bent to an outer peripheral side, and
the second cam face portion which structures the inner side cam face is formed so that both end portions in a circumferential direction of the recessed part are continuously formed with an inner wall face of the bending wall part in the turning center axial line direction.
